(19) United States
(12) Patent Application Publication
(10) Pub. No.: US 2009/0127411 A1
(43) Pub. Date: May 21, 2009

(54) Structure and mechanism of windshield mount and pedestal for portable electronics device

(76) Inventor: Antonio Aguilar, Torrance, CA (US)

Correspondence Address: MURAMATSU & ASSOCIATES, Suite 310, 114 Pacifica, Irvine, CA, 92618, US

(21) Appl. No.: 12/291,896

(22) Filed: Nov. 14, 2008

Related U.S. Application Data
(60) Provisional application No. 61/003,981, filed on Nov. 20, 2007.

(51) Int. Cl. B60R 11/00; F16M 13/02

(52) U.S. Cl. 248/205.8; 224/482

(57) ABSTRACT

A structure of the windshield mount and pedestal for mounting a portable electronic device on a windshield or other part of the vehicle is disclosed. The windshield mount and pedestal includes: a suction portion having a suction cup at its bottom; a protruded portion formed on the suction portion to establish a suction mechanism to move the suction cup in an up/down direction; a suction lever connected to the protruded portion to establish the suction mechanism; a device attachment portion for attaching a portable electronics device at one end; a pivotable arm pivotably connected to the suction portion to change a location of the portable electronics device; and a hollow portion formed at a bottom of the pivotable arm for receiving the protruded portion on the suction portion when the rotatable arm is pivoted fully downwardly.

This application claims the benefit of U.S. Provisional Application No. 61/003,981 filed Nov. 20, 2007.

### FIELD OF THE INVENTION

This invention relates generally to a mount and pedestal mechanism for a portable electronics device, and more particularly, to a structure and mechanism of windsield mount and pedestal for mounting a portable electronics device such as a navigation device on a windshield or dashboard, etc. of a vehicle that has a pivotable arm that collapses to a compact size when not in use.

### BACKGROUND OF THE INVENTION

Various portable electronics devices are used within a vehicle. Typical example is a portable navigation device (GPS: global positioning system) which performs travel guidance for enabling a user to easily and quickly reach the selected destination. A portable navigation device is gaining popularity for its convenience and low cost. In most cases, the portable navigation device is attached inside a vehicle when used as a vehicle navigation system. One method of mounting the portable navigation device is to attach the device via a windshield mount and pedestal that sticks to a windshield of a vehicle by a suction force.

FIGS. 1A-1C are schematic diagrams showing an example of structure of a conventional windshield mount and pedestal that attaches to a windshield of a vehicle. FIG. 1A shows a side view of the windshield mount and pedestal, FIG. 1B shows the situation where an arm 31 of the windshield mount and pedestal is bent, and FIG. 1C shows the situation where the windshield mount and pedestal is attached to a windshield 45 of a vehicle and a potable navigation device 41 mounted on a device support 35.

The windshield mount and pedestal comprises a suction cup 23, a suction lever 25, a suction base 27, a suction base cylinder 29, an arm 31, a device cylinder 33, a device support 35, and a device hook 37. The arm 31 is constructed to be elastic so that when the windshield mount and pedestal is attached to the windshield of a vehicle, a portable navigation device 41 attached to the device support 35 by means of the device hook 37 can be freely positioned. Thus, the windshield mount and pedestal allows a user (driver) to watch a display of the portable navigation device 41 at his/her desired angle. The suction cup 23 sticks to a windshield of a vehicle by its suction force.

Although it has the benefit of enabling to be attached and detached as desired, the windshield mount and pedestal can be bulky that takes up too much space, and can be aesthetically unappealing. Especially, in a summer season, internal temperature of a vehicle becomes very high which may shorten the life of the windshield mount and pedestal as well as the navigation device if these devices remain on the windshield. Thus, many users want to remove them from the vehicle to avoid the summer heat inside of the vehicle. In such a situation, it is necessary that, when not in use, the windshield mount and pedestal is able to become a small size, thereby enabling the user to put it in a pocket or handbag, etc. when the user leaves the vehicle.

### SUMMARY OF THE INVENTION

It is, therefore, an object of the present invention to provide a structure and mechanism of a windshield mount and pedestal which is capable of being collapsed in a manner to minimize its overall size when not in use.

It is another object of the present invention to provide a structure and mechanism of a windshield mount and pedestal which has a space or recess formed at a bottom of a pivotable arm for receiving a protruded portion of a suction portion to minimize the overall size when the windshield mount and pedestal is in the collapsed condition.

It is a further object of the present invention to provide a structure and mechanism of a windshield mount and pedestal with various modifications of the space or recess formed at the bottom of the pivotable arm for receiving the protruded portion of the suction portion.

The present invention is directed to the structure and mechanism of the windshield mount and pedestal for mounting a portable electronic device on a windshield or other part of the vehicle. The structure of the windshield mount and pedestal includes: a suction portion having a suction cup at its bottom for attaching the windshield mount and pedestal to a desired location of the vehicle with use of a suction force; a protruded portion formed on the suction portion to establish a suction mechanism to move the suction cup in an up/down direction; a suction lever connected to the protruded portion to establish the suction mechanism to move the suction cup in the up/down direction; a device attachment portion for attaching a portable electronics device at one end; a pivotable arm provided on the device attachment portion and is pivotably connected to the suction portion to change a location of the portable electronics device; and a hollow portion formed at a bottom of the pivotable arm for receiving the protruded portion on the suction portion when the rotatable arm is pivoted fully downwardly. The pivotable arm and the suction lever are oriented in the same direction when both of them are pivoted downwardly.

In the present invention, the windshield mount and pedestal further includes a suction cover formed over the suction cup which creates the suction force of the suction cup when the suction cup is pulled toward the suction cover by the suction mechanism. The suction cover is made of hard material while the suction cup is made of elastic material thereby creating the suction force of the suction cup when the suction cup is pulled and contact the suction cover by the suction mechanism.

In the present invention, the windshield mount and pedestal further includes a lever shaft for rotatably connecting the suction lever and the protruded portion wherein the lever shaft is connected to the suction cup and is movable in the up/down direction in response to the rotation of the suction lever. Further, the protruded portion has a tubular shape and formed at about the center of the suction portion through which the suction cup is connected to the lever shaft thereby allowing the suction cup to move in the up/down direction in response to the rotation of the suction lever.

In the windshield mount and pedestal of the present invention, the one end of the device attachment portion is an attachment ball which is a ball joint designed to snugly fit into a socket joint formed on a cradle or base that holds the portable electronics device.

In the present invention, the windshield mount and pedestal further includes a screw knob at a location where the pivotable arm is pivotably connected to the suction portion to fix the device attachment portion at a desired position or angle relative to the suction portion by fastening the screw knob.

The hollow portion is a recess or an indentation formed at the bottom of the pivotable arm for receiving the protruded portion on the suction portion when the rotatable arm is pivoted downwardly. Alternatively, the hollow portion is a through hole running from a bottom to a top of the pivotable arm for receiving the protruded portion on the suction portion when the rotatable arm is pivoted downwardly. In the case of through hole, the suction lever connected to the protruded portion is raised upwardly so that both the suction lever and the protruded portion are received in the through hole when the rotatable arm is pivoted downwardly.

In a further aspect, the pivotable arm is formed of two plates substantially in parallel with one another where a support portion is provided between the two plates at about the center thereof. The pivotable arm has an opening on a lower plate to form the hollow portion that is designed to receive the protruded portion when the rotatable arm is pivoted downwardly. The support portion provided between the two plates has a cut-out at a location of the opening of the lower plate, thereby forming the hollow portion to receive the protruded portion when the rotatable arm is pivoted downwardly. The two plates and the support portion of the pivotable arm are integral with one another.

According to the present invention, the windshield mount and pedestal enables to be collapsed in a manner to minimize its overall size when not in use. The windshield mount and pedestal has a space or recess formed at the bottom of the pivotable arm for receiving the protruded portion of the suction portion to minimize the overall size when the windshield mount and pedestal is in the collapsed condition. The structure and mechanism of the windshield mount and pedestal provides various modifications of the space or recess formed at the bottom of the pivotable arm for receiving the protruded portion of the suction portion. Thus, when the user wants to remove the windshield mount and pedestal from the vehicle, for example, to avoid the summer heat inside of the vehicle, the user can easily put the windshield mount and pedestal in a pocket or handbag, etc. and carry around, since its overall shape and size is minimized in the collapsed condition.

### BRIEF DESCRIPTION OF THE DRAWINGS

FIGS. 1A-1C are schematic diagrams showing an example of structure of a conventional windshield mount/pedestal that attaches to a windshield of a vehicle, where FIG. 1A is a side view of the conventional windshield mount, FIG. 1B is a side view of the conventional windshield mount where an arm of the windshield mount is bent, and FIG. 1C is a side view of the conventional windshield mount that is attached to a windshield and a portable navigation device is attached to a device support side.

FIGS. 2A-2C show an embodiment of a windshield mount and pedestal for a portable electronics device in the present invention having a hollow portion in a pivotable arm where FIG. 2A is a perspective view thereof, and FIGS. 2B and 2C are side views of the windshield mount and pedestal of FIG. 2A where FIG. 2C is partially cut-out to show the inside of the windshield mount and pedestal.

FIGS. 3A-3C further show the embodiment of FIGS. 2A-2C in the collapsed condition of the windshield mount and pedestal of the present invention where FIG. 3A is a top view thereof, FIG. 3B is a side view as seen from a direction A shown in FIG. 3A, and FIG. 3C is a side view as seen from a direction B shown in FIG. 3A.

FIG. 4 is a perspective view of the windshield mount and pedestal in the present invention where an arm is fully rotated (collapsed) to attain a minimum form.

FIGS. 5A-5D show another embodiment of a windshield mount and pedestal of the present invention having a through hole formed on the pivotable arm where FIG. 5A is a perspective view thereof, FIG. 5B is a top view thereof, and FIG. 5C is a perspective view showing the windshield mount and pedestal where the pivotable arm is collapsed, and FIG. 5D is a perspective view showing the windshield mount and pedestal where the suction lever is raised in the collapsed condition.

FIGS. 6A-6F show a further embodiment of the present invention where the windshield mount and pedestal of the present invention having a hole-shaped recess in the arm where FIG. 6A is a perspective view thereof when a device attachment portion and a suction portion are disconnected, FIG. 6B is a top view thereof when an arm is fully pivoted (collapsed), FIG. 6C is a side view thereof when the arm is fully pivoted (collapsed), FIG. 6D is a side view thereof showing the relationship between a hole-shaped recess and a protruded portion, FIG. 6E is a side view thereof when the arm is raised, and FIG. 6F is a side view of the support portion formed inside of the pivotable arm.

FIG. 7A is a bottom view of the device attachment portion of the windshield mount and pedestal in the embodiment of FIGS. 6A-6F, and FIG. 7B is a side view of the device attachment portion shown in FIG. 7A.

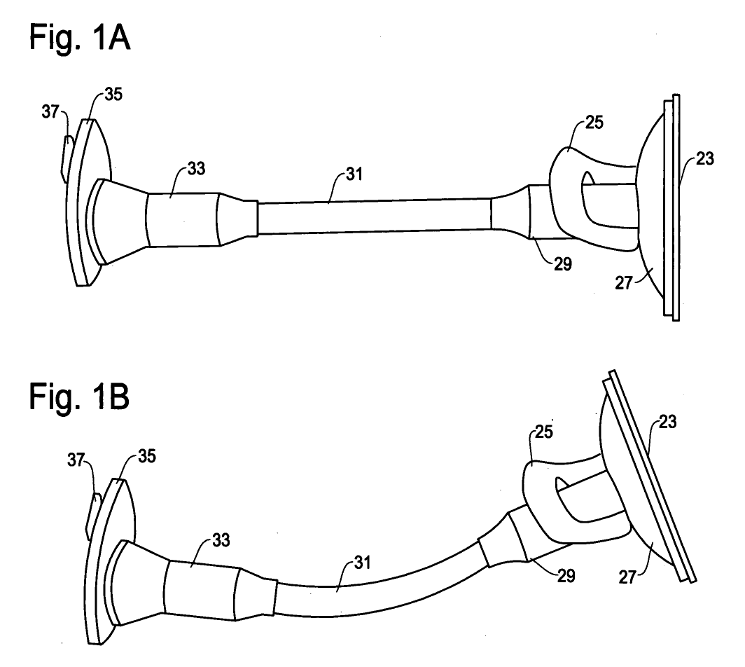

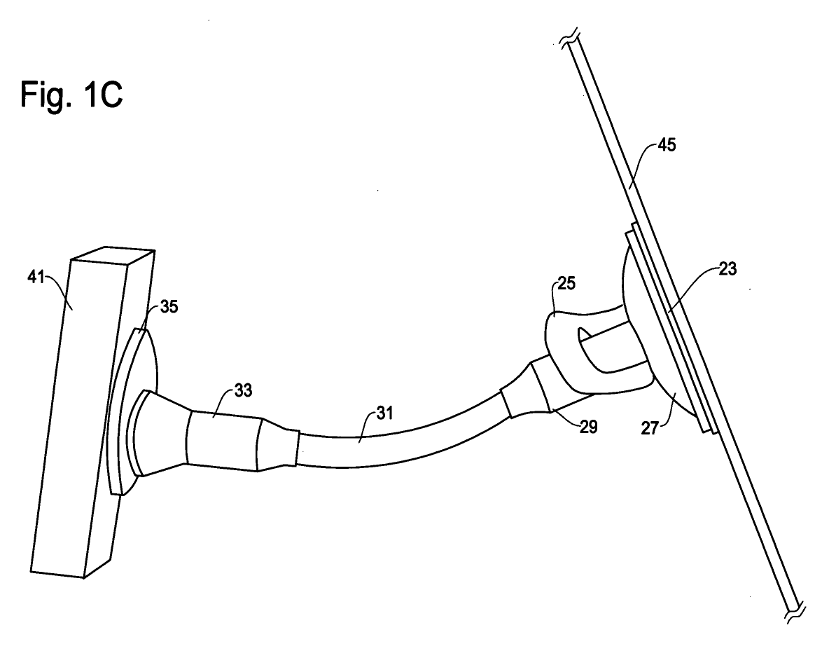

### DETAILED DESCRIPTION OF THE PREFERRED EMBODIMENT

The structure and mechanism of the windshield mount and pedestal for a portable navigation device in the present invention is described in detail with reference to the accompanied drawing. The windshield mount and pedestal is designed so that, when not in use, it can be uniquely collapsed to attain a small shape and size thereby enabling the user to easily carry around. It should be noted that although the windshield mount and pedestal of the present invention is described for the case of mounting a portable navigation device for an illustration purpose, the present invention can be advantageously implemented to mount any type of portable electronics device.

The windshield mount and pedestal of the present invention is comprised of a suction portion by which the windshield mount and pedestal sticks to a vehicle windshield and a device attachment portion by which the portable navigation device is attached. A pivotable arm is provided on the device attachment portion and is pivotably connected to the suction portion. The pivotable arm has a hollow portion at its bottom that provides a space for a projected portion of the suction portion when the rotatable arm is pivoted all the way downwardly when windshield mount and pedestal is not in use (collapsed condition).

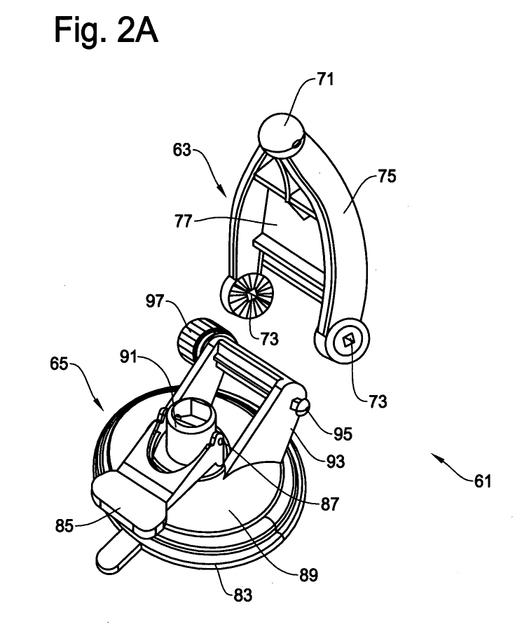

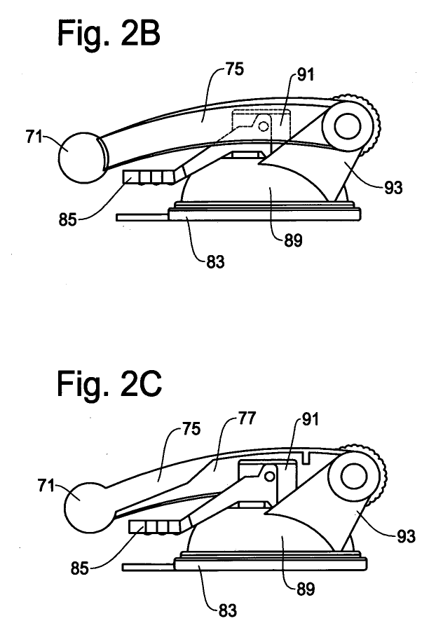

FIGS. 2A-2C show an embodiment of the windshield mount and pedestal of the present invention where FIG. 2A is a perspective view thereof for a portable navigation device, and FIGS. 2B and 2C are side views of the windshield mount and pedestal of FIG. 2A where FIG. 2C is partially cut-out to show the inside of the windshield mount and pedestal. In this example, a windshield mount and pedestal 61 of the present invention is mainly composed of a device attachment portion 63 and a suction portion 65.

In the perspective view of FIG. 2A, the device attachment portion 63 and the suction portion 65 are detached from each other. The device attachment portion 63 has an attachment ball 71 at its one end to which a portable navigation device is attached. The attachment ball 71 is a ball joint designed to snugly fit into a socket joint that is a round inside formed on a cradle or base (not shown) to hold the portable navigation device.

At another end of the device attachment portion 63, there is provided with hinge holes 73 which will be attached to a shaft 95 formed on a support 93 on the suction portion 65 when the device attachment portion 63 and suction portion 65 are connected. Between the attachment ball 71 and the hinge holes 73 of the device attachment portion 63 constitutes a pivotable arm 75. A screw knob 97 is used to fasten the device attachment portion 63 (i.e., the pivotable arm 75) to a fixed position or a desired angle relative to the suction portion 65 based on the user's preference, etc.

Thus, the device attachment portion 63 as a whole is pivotably connected to the suction portion 65 in such a way that the pivotable arm 75 rotates about the shaft 95 to change a location of the portable electronics device. As best seen from the perspective view of FIG. 2A, a hollow portion 77 is provided at the bottom of the pivotable arm 75. As will be described later in detail, the hollow portion 77 is one example of a means of providing space to receive a protruded portion 91 of the suction portion 65.

The suction portion 65 has a suction cup 83 made of elastic material so that it sticks to a windshield of a vehicle or other smooth surface formed on a dashboard of the vehicle via a suction force. A suction cover 89 is designed to cover the suction cup 83 as well as to serve as the base of the windshield mount and pedestal 61. A suction lever 85 is used for causing a vacuum action to stick the suction cup 83 to a desired surface of the vehicle.

The suction lever 85 is rotatably connected to a protruded portion 91 which is a base formed on the suction cover 89. A lever shaft 87 is provided to the protruded portion 91 to allow the suction lever 85 to rotate (pivot) about the lever shaft 87. The protruded portion 91 has a tubular shape and formed at about the center of the suction portion 65 through which the suction cup 83 is connected to the lever shaft 87.

Since the portion of the suction lever 85 that is connected to the protruded portion 91 by the lever shaft 87 is shaped as a cam or a cam mechanism, when the suction lever 85 is rotated, the lever shaft 87 connected to the suction cup 83 moves up and down, thereby pulling the suction cup 83 toward the suction cover 89 and contacting the suction cover 89 to create the vacuum action. Namely, the suction cover 89 is made of hard material while the suction cup 83 is made of elastic material thereby creating the suction force of the suction cup 83 when the suction cup 83 is pulled and contact the suction cover 89 by the action of the suction lever 85 (suction mechanism).

FIGS. 2B and 2C are side views of the windshield mount and pedestal 61 shown in FIG. 2A when the pivotable arm 75 is fully pivoted downward. FIG. 2B shows an inside of the pivotable arm 75 by dotted lines and FIG. 2C is a partially cut-out view showing the inside of the pivotable arm 75. As shown in FIG. 2B, the protruded portion 91 to which the suction lever 85 is attached to is received within an inside space of the pivotable arm 75 when the device attachment portion 63 is in the collapsed condition, i.e., the pivotable arm 75 is fully pivoted downward.

More specifically, as shown in FIG. 2C, the pivotable arm 75 has a hollow portion 77 which is a recess or an indentation formed on the bottom of the pivotable arm 75 and designed to have an enough space and suited configuration to receive the protruded portion 91. Thus, depending on the size and shape of the protruded portion 91, the size and shape of the hollow portion 77 will vary accordingly. Moreover, as will be described in more detail later, the hollow portion 77 may take other shape and size to receive the protruded portion 91 in different manners.

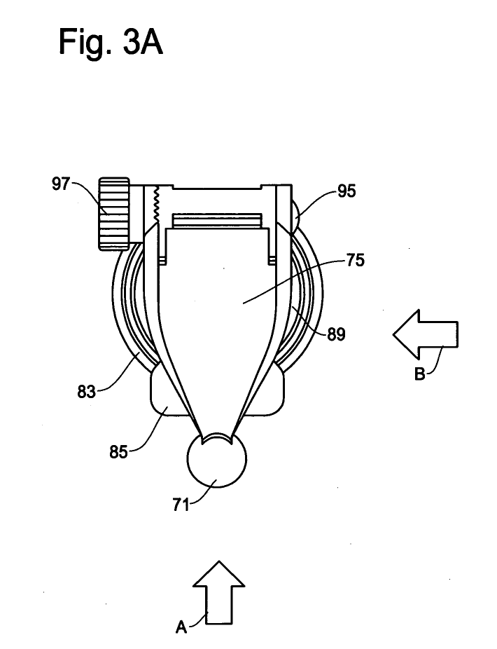

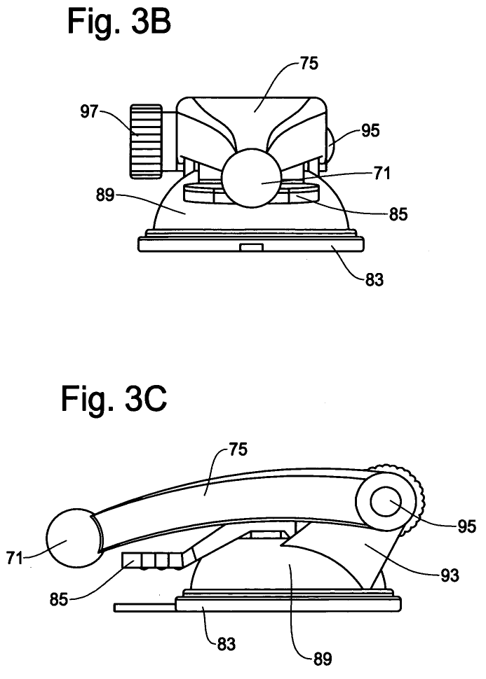

FIG. 3A is a top view of the windshield mount and pedestal 61 of the present invention in the collapsed condition. As shown in FIGS. 2B and 2C noted above, the device attachment portion 63 is collapsed fully toward the suction portion 65 due to the hollow portion 77 provided in the pivotable arm 75 that receives the protruded portion 91. Consequently, the overall size of the windshield mount and pedestal 61 is minimized when it is not in use.

FIG. 3B is a side view of the windshield mount and pedestal 61 as seen from direction A indicated in FIG. 3A and FIG. 3C is a side view of the windshield mount and pedestal 61 as seen from direction B indicated in FIG. 3A. As shown, the pivotable arm 75 of the device attachment portion 63 is fully rotated toward the suction portion 65. Thus, the overall size, such as a height is minimized as shown in FIGS. 3B and 3C so that the user can easily carry around the windshield mount and pedestal 61.

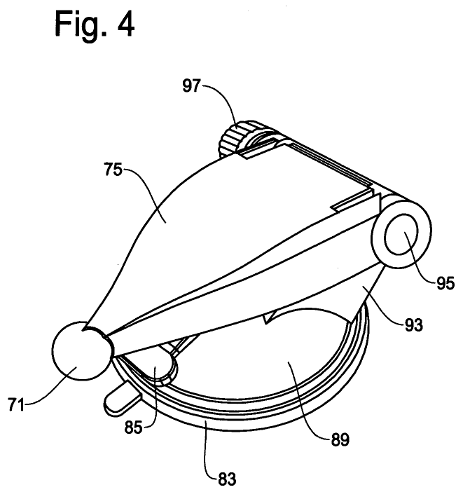

FIG. 4 is a perspective view of the windshield mount and pedestal 61 in the present invention in the collapsed condition similar to that of FIGS. 3B and 3C. As seen from FIG. 4, the pivotable arm 75 is fully pivoted (collapsed) downwardly so that the windshield mount and pedestal 61 is folded into a minimum size. Thus, when the user wants to remove the windshield mount and pedestal 61 from the vehicle to avoid the summer heat inside of the vehicle, for example, the user can easily put the windshield mount and pedestal 61 in a pocket or handbag, etc. and carry around, since its overall size is minimized in the collapsed condition. As also seen from FIG. 4, the pivotable arm 75 and the suction lever 85 are oriented in the same direction when both of them are pivoted downwardly (collapsed condition).

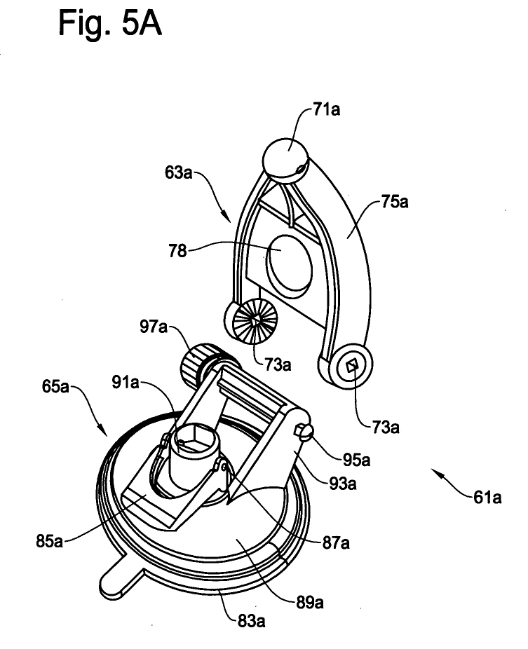

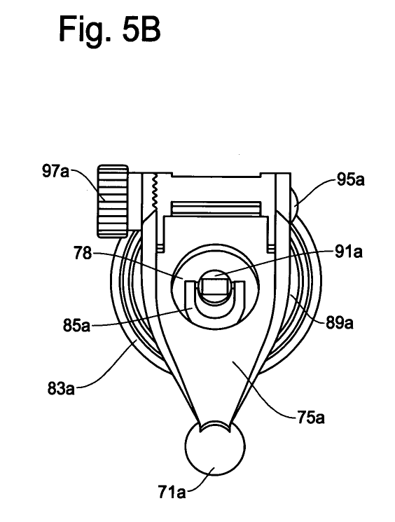

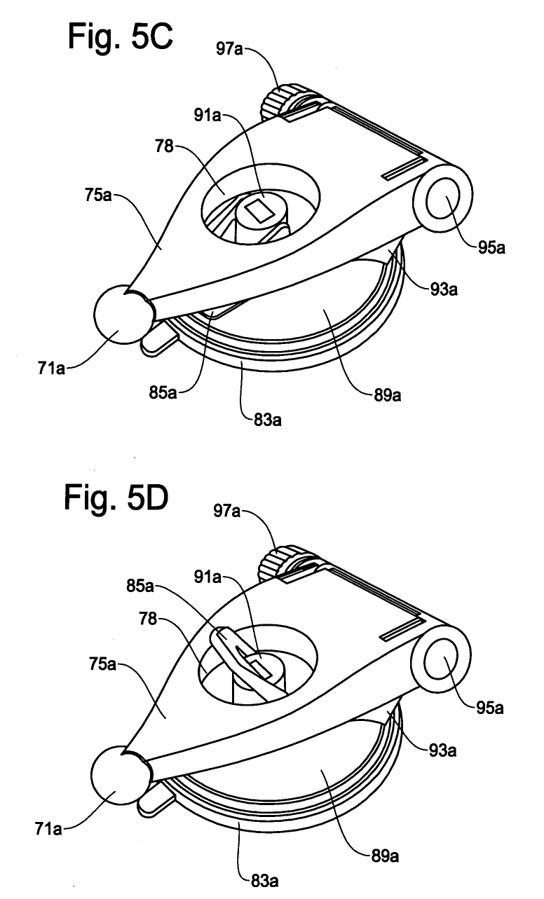

Another embodiment of the windshield mount and pedestal 61a of the present invention is described with reference to FIGS. 5A-5D. Components corresponding to that shown and described with reference to FIGS. 2A-2C, 3A-3C and 4 are denoted by the same reference numeral with addition of character “a”. FIG. 5A is a perspective view when the suction portion and the device attachment portion are disconnected, FIG. 5B is a top view, and FIG. 5C is a perspective view showing an example of collapsed condition, and FIG. 5D is a perspective view showing another example of collapsed condition.

In the example of FIG. 5A, the suction portion 65a and the device attachment portion 63a of the windshield mount and pedestal 61a are separated from one another to show the structure and mechanism thereof clearly. In the pivotable arm 75a, there is provided with a hole 78 to establish a space or recess for receiving the protruded portion 91a on the suction portion 65a. The collapsed condition of FIG. 5C is effective for decreasing the overall size, however, the collapsed condition of FIG. 5D is even more effective by resting the suction lever 85a in the hole 78.

The hole 78 in this embodiment is equivalent to the hollow portion 77 in the windshield mount and pedestal 61 shown in FIGS. 2A-2C, 3A-3C and 4. The main difference between the windshield mount and pedestal 61 and the windshield mount and pedestal 61a lies in the hole 78 which is a through hole running from the bottom to the top of the pivotable arm 75a to receive the protruded portion 91a. Moreover, the end of the suction lever 85a is designed to be narrower and shorter than that in the previous example shown in FIGS. 2A-2C, 3A-3C and 4. Although the hole 78 is circular shape in FIGS. 5A-5D, any other shape may be used for the purpose of receiving the protruded portion 91a.

FIG. 5B shows the top view of the windshield mount and pedestal 61a having the hole 78 on the pivotable arm 75a. As shown, the protruded portion 91a of the suction portion 65a is received in the space of the hole 78 when the pivotable arm 75 is fully rotated in the collapsed condition. Unlike the example of FIGS. 2A-2C, 3A-3C and 4, the hole 78 (hollow portion) is a through hole which that goes from inside to outside of the pivotable arm 75a.

FIG. 5C is a perspective view showing the windshield mount and pedestal 61a where the pivotable arm 75a is fully pivoted in the collapsed condition so that the protruded portion 91a of the suction portion 65a is received in the space of the hole 78. FIG. 5D is a perspective view similar to that of FIG. 5C, except that the suction lever 85a is pointed upward. In this condition, the suction lever 85a on the suction cover 89a is lifted up to release the air pressure in the suction cup 83 to release the windshield mount and pedestal 61a from a windshield surface. As the suction lever 85a as well as the protruded portion 91a are received in the hole 78, this structure allows the pivotable arm 75a to further rotate downwardly to establish the minimum overall size of the windshield mount and pedestal 61a.

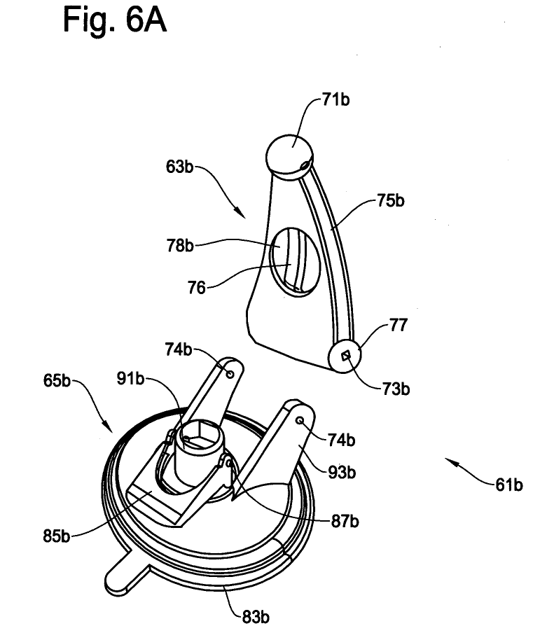

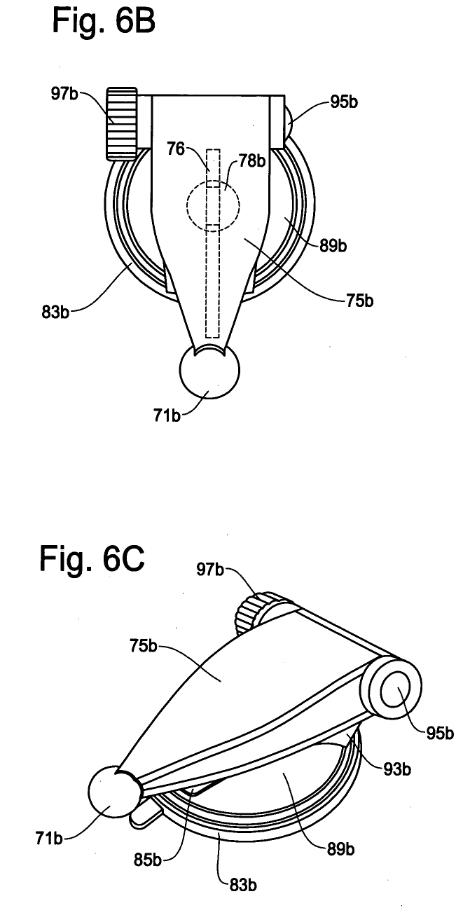

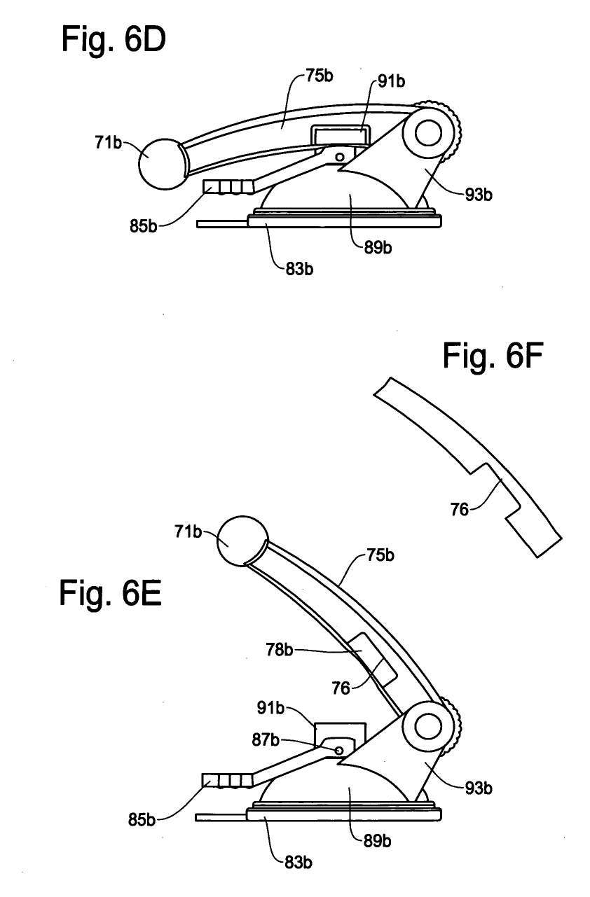

FIGS. 6A-6F show still another embodiment of the present invention where the windshield mount and pedestal 61b has a hole-shaped recess 78b, which corresponds to the hollow portion 77 in the windshield mount and pedestal 61 shown in FIGS. 2A-2C, 3A-3C and 4. Components corresponding to that shown and described with reference to FIGS. 2A-2C, 3A-3C, 4 and 5A-5D are denoted by the same reference numeral with addition of character “b”.

FIG. 6A is a perspective view showing the windshield mount and pedestal 61b when the device attachment portion 63b and suction portion 65b are separated from one another. A pin will be inserted through the hinge holes 73b and the hinge holes 74b such that the device attachment portion 63b and the suction portion 65b are rotatably connected with each other. The pivotable arm 75b is basically formed of two plates substantially in parallel with one another where a support portion 76 is provided between the two plates at about the center thereof. The lower (bottom) plate of the pivotable arm 75b has an opening and the support portion 76 above the opening is cut-out to create a hole-shaped recess 78b that is designed to receive the protruded portion 91b.

FIG. 6B shows a top view of the windshield mount and pedestal 61b showing the condition where the pivotable arm 75b is rotated downwardly (collapsed). Although invisible in an actual application, the top view of FIG. 6B also shows the support portion 76 and the hole-shaped recess 78b by the dotted lines for an illustration purpose. The support portion 76 runs at about the center of the pivotable arm 75b between the two plates thereof.

FIG. 6C is a perspective view showing the windshield mount and pedestal 61b where the pivotable arm 75b is fully pivoted downwardly in the collapsed condition. Thus, the protruded portion 91b of the suction portion 65b is received in the space of the hole-shaped recess 78b. FIG. 6D is a side view of the windshield mount and pedestal 61b in the same condition as that of FIG. 6C and shows the relationship between the hole-shaped recess 78b and the protruded portion 91b.

FIG. 6E is a side view showing the condition where the pivotable arm 75b is pivoted upwardly. As shown, the pivotable arm 75b can rotate about the hinge holes 74b (FIG. 6A) up and down, and the cut-out of the support portion 76 is provided at the back of the hole-shaped recess 78b. FIG. 6F is a side view of the support portion 76 to show its shape, although the support portion 76 and the two plates of the pivotable arm 75b are integrally formed in an actual application.

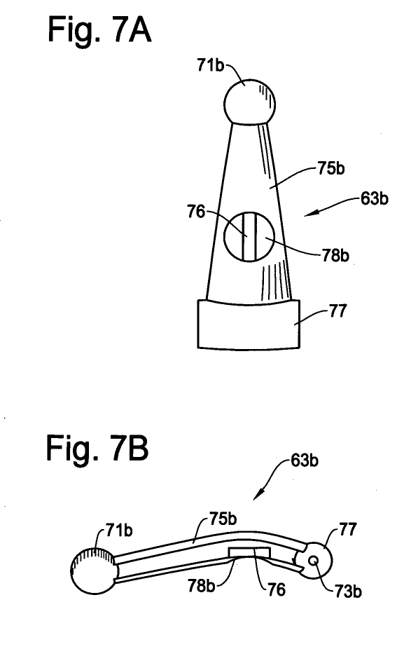

FIGS. 7A and 7B shows the pivotable arm 75b of the device attachment portion 63b described above with reference to FIGS. 6A-6F where FIG. 7A is a bottom view and FIG. 7B is a side view. The pivotable arm 75b has the hole-shaped recess 78b, and in the inside of the hole-shaped recess 78b is the cut-out of the support portion 76. The support portion 76 may contact with the top of the protruded portion 91b as shown in the side view of FIG. 6D when the pivotable arm 75b is fully rotated downward.

As has been described above, according to the present invention, the windshield mount and pedestal enables to be collapsed in a manner to minimize its overall size when not in use. The windshield mount and pedestal has a space or recess formed at the bottom of the pivotable arm for receiving the protruded portion of the suction portion to minimize the overall size when the windshield mount and pedestal is in the collapsed condition. The structure and mechanism of the windshield mount and pedestal provides various modifications of the space or recess formed at the bottom of the pivotable arm for receiving the protruded portion of the suction portion. Thus, when the user wants to remove the windshield mount and pedestal from the vehicle, for example, to avoid the summer heat inside of the vehicle, the user can easily put the windshield mount and pedestal in a pocket or handbag, etc. and carry around, since its overall shape and size is minimized in the collapsed condition.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A structure of windshield mount and pedestal for mounting a portable electronics device on a windshield or other location in a vehicle, comprising:
a suction portion having a suction cup at its bottom for attaching the windshield mount and pedestal to a desired location of the vehicle with use of a suction force;
a protruded portion formed on the suction portion to establish a suction mechanism to move the suction cup in an up/down direction;
a suction lever connected to the protruded portion to establish the suction mechanism to move the suction cup in the up/down direction;
a device attachment portion for attaching a portable electronics device at one end;
a pivotable arm provided on the device attachment portion and is pivotably connected to the suction portion to change a location of the portable electronics device; and
a hollow portion formed at a bottom of the pivotable arm for receiving the protruded portion on the suction portion when the rotatable arm is pivoted fully downwardly.

2. A structure of windshield mount and pedestal as defined in claim 1, further comprising a suction cover formed over the suction cup which creates the suction force of the suction cup when the suction cup is pulled toward the suction cover by the suction mechanism.

3. A structure of windshield mount and pedestal as defined in claim 2, wherein said suction cover is made of hard material while the suction cup is made of elastic material thereby creating the suction force of the suction cup when the suction cup is pulled and contact the suction cover by the suction mechanism.

4. A structure of windshield mount and pedestal as defined in claim 1, further comprising a lever shaft for rotatably connecting the suction lever and the protruded portion wherein the lever shaft is connected to the suction cup and is movable in the up/down direction in response to the rotation of the suction lever.

5. A structure of windshield mount and pedestal as defined in claim 4, wherein said protruded portion has a tubular shape and formed at about the center of the suction portion through which the suction cup is connected to the lever shaft thereby allowing the suction cup to move in the up/down direction in response to the rotation of the suction lever.

6. A structure of windshield mount and pedestal as defined in claim 1, wherein said one end of the device attachment portion is an attachment ball which is a ball joint designed to snugly fit into a socket joint formed on a cradle or base that holds the portable electronics device.

7. A structure of windshield mount and pedestal as defined in claim 1, further comprising a screw knob at a location where the pivotable arm is pivotably connected to the suction portion to fix the device attachment portion at a desired position or angle relative to the suction portion by fastening the screw knob.

8. A structure of windshield mount and pedestal as defined in claim 1, wherein said hollow portion is a recess or an indentation formed at the bottom of the pivotable arm for receiving the protruded portion on the suction portion when the rotatable arm is pivoted downwardly.

9. A structure of windshield mount and pedestal as defined in claim 1, wherein said hollow portion is a through hole running from a bottom to a top of the pivotable arm for receiving the protruded portion on the suction portion when the rotatable arm is pivoted downwardly.

10. A structure of windshield mount and pedestal as defined in claim 9, wherein said suction lever connected to the protruded portion is raised upwardly so that both the suction lever and the protruded portion are received in the through hole when the rotatable arm is pivoted downwardly.

11. A structure of windshield mount and pedestal as defined in claim 1, wherein said pivotable arm is formed of two plates substantially in parallel with one another where a support portion is provided between the two plates at about the center thereof.

12. A structure of windshield mount and pedestal as defined in claim 11, wherein said pivotable arm has an opening on a lower plate to form the hollow portion that is designed to receive the protruded portion when the rotatable arm is pivoted downwardly.

13. A structure of windshield mount and pedestal as defined in claim 12, wherein said support portion provided between the two plates has a cut-out at a location of the opening of the lower plate, thereby forming the hollow portion to receive the protruded portion when the rotatable arm is pivoted downwardly.

14. A structure of windshield mount and pedestal as defined in claim 11, wherein said two plates and said support portion of the pivotable arm are integral with one another.

15. A structure of windshield mount and pedestal as defined in claim 1, wherein said pivotable arm and said suction lever are oriented in the same direction when both of them are pivoted downwardly.
